(19) United States
(12) Patent Application Publication
(10) Pub. No.: US 2016/0178353 A1
(43) Pub. Date: Jun. 23, 2016

(54) APPARATUS AND METHOD FOR OBTAINING DEPTH INFORMATION IN A SCENE

(71) Applicant: INDUSTRIAL TECHNOLOGY RESEARCH INSTITUTE, Hsinchu (TW)

(72) Inventors: Ludovic ANGOT, Hsinchu City (TW); Wei-Yi LEE, Tainan City (TW)

(73) Assignee: INDUSTRIAL TECHNOLOGY RESEARCH INSTITUTE, Hsinchu (TW)

(21) Appl. No.: 14/576,636

(22) Filed: Dec. 19, 2014

(51) Int. Cl. G01B 11/14; H04N 5/225; H04N 5/33; G06T 7/00

(52) U.S. Cl. CPC G01B 11/14; G06T 7/0081; H04N 5/2256; H04N 5/33

(57) ABSTRACT

An apparatus and a method for obtaining depth information in a scene are provided. The apparatus may include an imaging device for capturing an image of the scene and at least one non-imaging depth sensor. An image of the scene is captured by the imaging device and then segmented to obtain a segmented image of an object in at least one region of interest. The non-imaging depth sensor measures a distance from the imaging device to the object in the at least one region of interest of the image captured by the imaging sensor. A depth may be assigned to the at least one segment of the object according to the measured distance.

### TECHNICAL FIELD

The disclosure relates to an apparatus and a method for obtaining depth information in a scene.

### BACKGROUND

There exist several approaches to measure distances with an optical device. For instance, commercial depth measurement imaging devices based on Time-of-flight perform well indoors but their usability is limited outdoors. Though imaging devices based on stereo matching approach can perform well outdoors under natural light, they often require intensive computations making their implementation on current mobile computing platform difficult.

Depth evaluation using infrared light in combination with an infrared sensitive camera have been studied , but it is well known that light reflected by objects depends on the reflectivity of the objects, leading to that some highly reflective objects located far from the camera may appear closer than objects with low reflectivity located near to the camera. Due to the high variability in the reflectivity of materials, measuring distances based on the amount of light reflected by an object is highly unreliable.

### SUMMARY

The disclosure is directed to an apparatus and a method for obtaining depth information in a scene.

According to one embodiment, an apparatus for obtaining depth information in a scene is provided. The apparatus includes an imaging device and at least one non-imaging depth sensor. The imaging device includes a lens, an imaging sensor, and a processing unit capable of performing computation operations on the image. The imaging device is for capturing an image of the scene and at least one non-imaging depth sensor is for measuring a distance from the imaging device to an object in at least one region of interest of the image captured by the imaging sensor. The processing unit assigns a depth to the object in the at least one region of interest according to the measured distance.

According to another embodiment, a method for obtaining depth information in a scene is provided. The method includes the following steps: An image of the scene is captured by an imaging device. The image may be segmented to obtain at least one segment of an object in at least one region of interest. A distance from the imaging device to the object in the at least one region of interest is measured by a non-imaging depth sensor. Depth is assigned to the at least one segment of the object according to the measured distance in the at least one region of interest.

According to an alternative embodiment, a method for obtaining depth information in a scene is provided. The method includes the following steps: A distance from the imaging device to an object located in a region of interest in the scene is measured by a non-imaging depth sensor. A reflectivity of the object is computed according to the measured distance. The scene is illuminated with an invisible light light source. An image of the scene is captured by an imaging device. The image is segmented to obtain at least one segment of the object in the at least one region of interest. The intensity of each pixel in the at least one segment is corrected by using the computed reflectivity. A depth is assigned to each pixel in the at least one segment based on the corrected intensity.

### BRIEF DESCRIPTION OF THE DRAWINGS

FIG. 1 is a schematic view of an apparatus for obtaining depth information in a scene according to a first embodiment.

FIG. 2 illustrates a flow chart of a method for obtaining depth information in the scene according to the first embodiment.

FIG. 3 is another schematic view of the apparatus for obtaining depth information in the scene according to the first embodiment.

FIGS. 4A and 4B show segmented images of objects in regions of interest without and with depth information respectively.

FIG. 5 is a schematic view of an apparatus for obtaining depth information in a scene according to a second embodiment.

FIG. 6 illustrates a flow chart of a method for obtaining depth information in the scene according to the second embodiment.

FIG. 7 illustrates the reflectivity calibration in FIG. 6.

FIG. 8 illustrates a flow chart of a depth-based segmentation image processing according to the second embodiment.

FIG. 9 illustrates a flow chart of a matting image processing according to the second embodiment.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

### First Embodiment

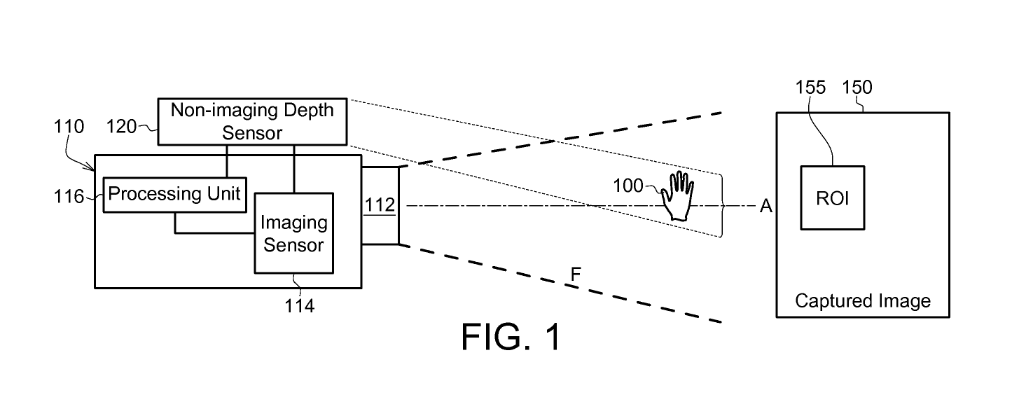

Referring to FIG. 1, a schematic view of an apparatus for obtaining depth information in a scene according to a first embodiment is shown. The apparatus includes an imaging device 110 and at least one non-imaging depth sensor 120. The imaging device 110 includes a lens 112, an imaging sensor 114, and a processing unit 116 capable of performing computation operations on the captured image 150. The imaging device 110 is for capturing an image 150 of the scene and the at least one non-imaging depth sensor 120 is for measuring a distance from the imaging device 110 to an object 100 in at least one region of interest (ROI) 155 of the image 150 captured by the imaging sensor 114. The processing unit 116 assigns a depth to the object 100 in the at least one ROI 155 according to the measured distance.

The imaging sensor 114 is sensitive to invisible light and the lens 112 allows invisible light to pass. Alternatively, the imaging sensor 114 can be sensitive to both visible and invisible light. The lens 112 has an optical axis A and a field of view F, and the directivity of the non-imaging depth sensor 120 can be steered along a direction within the field of view F toward a direction of the object 100 in the at least one ROI 155. The non-imaging depth sensor 120 can be an ultrasound transducer or a phase detection sensor. The phase detection sensor can be integrated into the imaging sensor 120. The pixels used for phase detection can be a 2-dimensional array or a simple line array.

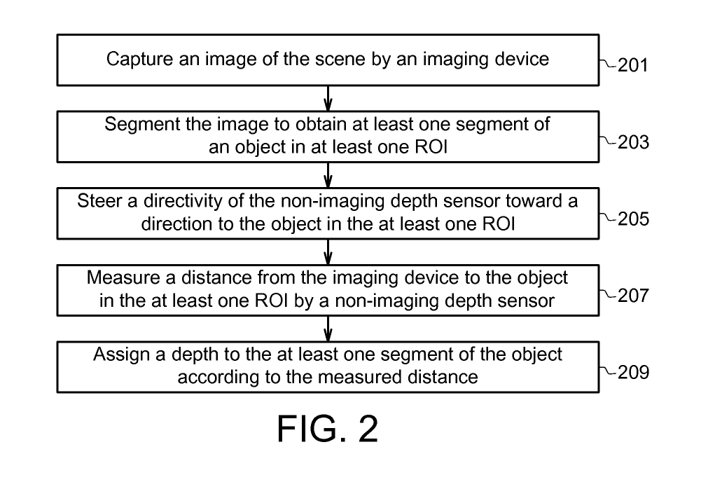

Referring to both of FIGS. 1 and 2, FIG. 2 illustrates a flow chart of a method for obtaining depth information in the scene according to the first embodiment. The method includes the following steps: In step 201, the image 150 of the scene is captured by the imaging device 110. In step 203, the image 150 is segmented to obtain at least one segment of the object at least one segment of the object 100 in at least one region of interest (ROI) 155. Step 205 may be optional, and consists in steering the directivity of the non-imaging depth sensor 120 toward the direction of the object 100 in the at least one ROI 155. In step 207, a distance from the imaging device 110 to the object 100 in the at least one ROI is measured by the non-imaging depth sensor 120. In step 209, a depth is assigned to the at least one segment of the object 100 according to the measured distance.

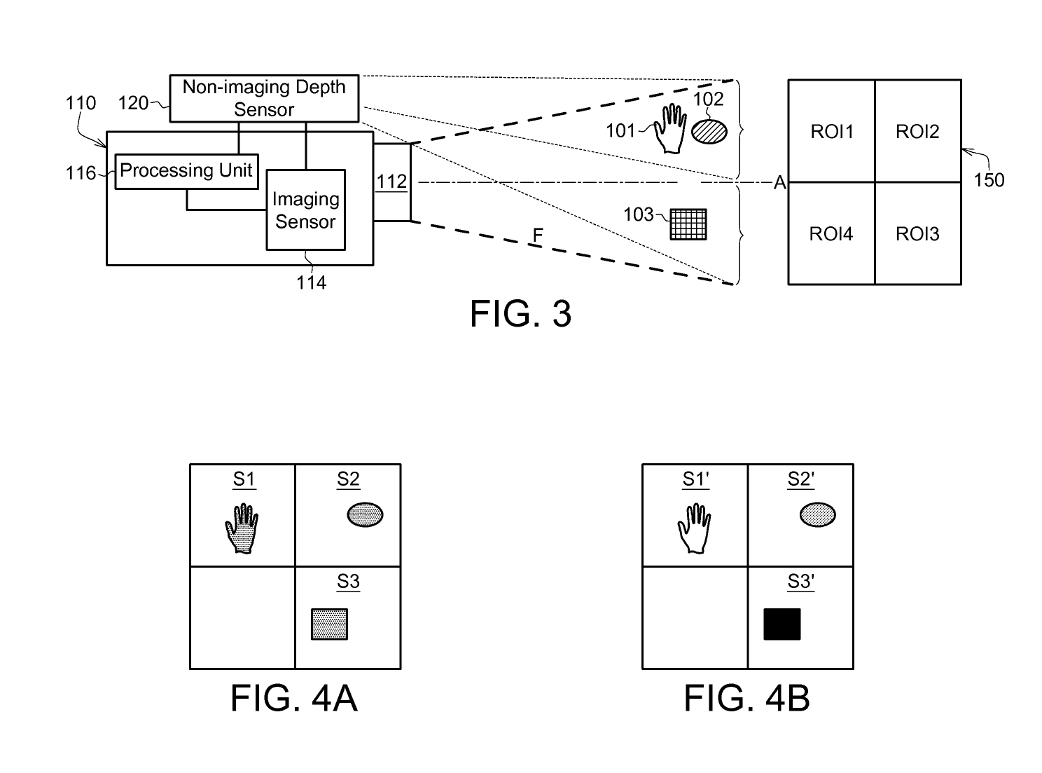

Referring to FIG. 3, another schematic view of the apparatus for obtaining depth information in a scene according to the first embodiment is illustrated. As shown in FIG. 4A, the captured image 150 is segmented to obtain a segment S1 of the object 101 in the region of interest ROI1, a segment S2 of the object 102 in the region of interest ROI2, and a segment S3 of the object 103 in the region of interest ROI3. The directivity of the non-imaging depth sensor 120 can be steered toward the directions of the objects 101, 102 and 103 in the regions of interest ROI1, ROI2 and ROI3 respectively. The non-imaging depth sensor can also be constituted of an array of sensors and therefore selectively provide distance information in the regions of interest. Distances from the imaging device 110 to the objects 101, 102 and 103 in the regions of interest ROI1, ROI2 and ROI3 respectively, are measured by the non-imaging depth sensor 120. Depths are assigned to the segments S1, S2 and S3 of the objects 101, 102 and 103 according to the measured distances. FIG. 4B shows segmented images S1′, S2′ and S3′ of objects 101, 102 and 103 in regions of interest R011, R012 and R013 with depth information respectively. In FIG. 4B, the representation of a depth map chosen as an example shows the object 101 with bright intensity as being the closest to the imaging device 110, the object 102 being further away from the imaging device 110 than the object 101, and the object 103 being the furthest away from the imaging device 110. Other depth map representations exist.

### Second Embodiment

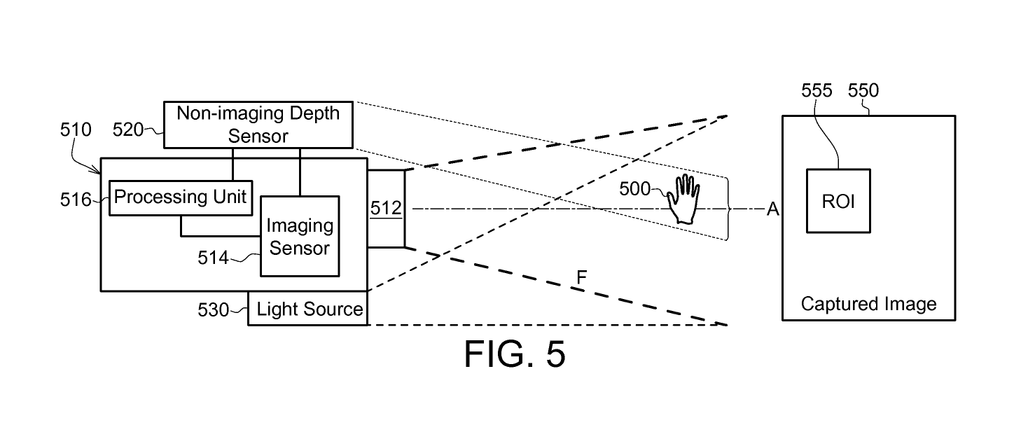

Referring to FIG. 5, a schematic view of an apparatus for obtaining depth information in a scene according to a second embodiment is shown. The apparatus includes an imaging device 510, at least one non-imaging depth sensor 520, and a light source 530. The imaging device 510 includes a lens 512, an imaging sensor 514, and a processing unit 516 capable of performing computation operations on the image 550. The imaging device 510 is for capturing an image 550 of the scene and the at least one non-imaging depth sensor 520 is for measuring a distance from the imaging device 510 to an object 500 in at least one region of interest (ROI) 555 of the image 550 captured by the imaging sensor 514. The processing unit 516 assigns a depth to the object 500 in the at least one ROI 555 according to the measured distance. The light source 530 is an invisible light light source, such as a source of infrared light. The light source 530 illuminates the object 500 of the scene with invisible light within the field of view F of the lens 512. The directivity of the non-imaging depth sensor 520 is steerable toward the direction of the object 500 in the at least one ROI 555 within the field of view F.

As compared with the apparatus in FIG. 1, details of the imaging device 510 and the non-imaging depth sensor 520 are similar to those of the imaging device 110 and the non-imaging depth sensor 120. The apparatus according to the second embodiment is further equipped with the invisible light light source 530 to perform the method of obtaining the depth information with illumination.

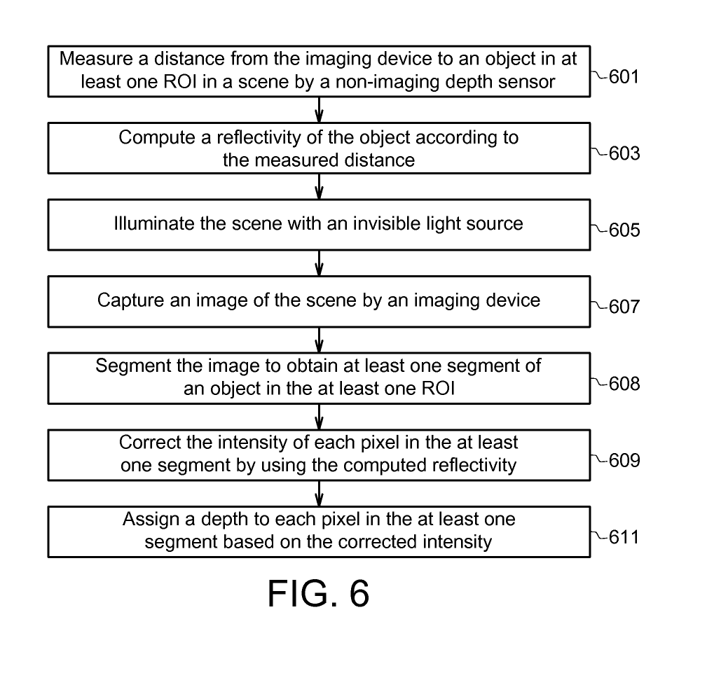

Referring to both of FIGS. 5 and 6, FIG. 6 illustrates a flow chart of a method for obtaining depth information in the scene according to the second embodiment. The method includes the following steps: In step 601, a distance from the imaging device 510 to the object 500 in at least one ROI 555 in the scene is measured by the non-imaging depth sensor 520. In step 603, a reflectivity of the object 500 is computed according to the measured distance by the processing unit 516. After the scene is illuminated with the invisible light light source 530 in step 605, the imaging device 510 captures the image 550 of the scene in step 607. In step 608, the image 550 is segmented to obtain at least one segment of the object 500 in at least one region of interest (ROI) 555. The image 550 of the scene may be captured in an invisible domain of the optical spectrum. Alternatively, the image 550 of the scene can be captured both in invisible and visible domains of the optical spectrum. Then, in step 609, the intensity of each pixel in the at least one segment is corrected by using the computed reflectivity. The depth is assigned to each pixel in the at least one segment based on the corrected intensity in step 611.

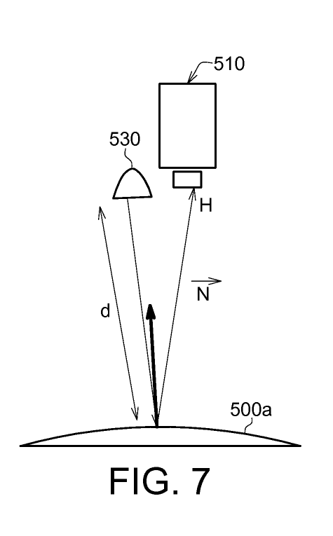

FIG. 7 illustrates, in one of exemplary embodiments, for reflectivity computation in step 603 of FIG. 6. The invisible light light source 530 illuminates the surface of object 500a with invisible light, and the imaging device 510 captures the invisible light intensity image. The intensity image of the light reflected by the object may be a function of the illumination, the illumination direction, the object reflectivity and the distance between the light source to the object and the object to the imaging device. For simplicity, the light source and the imaging device are supposed to be collocated.

Referring to FIG. 7, in one of exemplary embodiments, the irradiance H is the light power incident on the surface of the object and is expressed in (W/sr/m²). H₁ is the irradiance at the surface of the object, it is equal to H₁=J/d² where d is the distance from the light source to the object and J is the light source radiant intensity, J=P/(4π), where P is the light emitted power in W. After reflection, the irradiance at the image sensor is H₂˜ρJ/d⁴ where ρ is a coefficient proportional to the reflectivity of the surface of the object under a given incidence and for a given wavelength.

The coefficient p can be evaluated using for example a Phong model. Noting I the intensity reflected by the surface of the object, it can be written as the following equation (1):

I=C₀ cos(α)+C₁ cos^{ts}(2α)

where α may be obtained by the incidence angle between the normal to the surface of the object and the directivity of the light source, the parameters C₀ and C₁ are related to the reflectivity of the object. The pixel intensity E may be obtained according to the following equation (2), where A is the area of the object being imaged:

E=IA/(2d)²

From equations (1) and (2), the pixel intensity E may be computed by the following equation:

$$E = \frac{{C}_{0} cos ( α ) + {C}_{1} cos ( 2 α )}{{[ \frac{d}{cos ( α )} + r ( \frac{1}{cos ( α )} - 1 ) ]}^{2}} .$$

Knowing the distance from the non-imaging depth sensor, several measurements can be taken in order to obtain the parameters C₀ and C₁. Assuming angle α approaches 0, the pixel intensity E is: E=(C₀+C₁)/d². The distance d may then be evaluated by d=((C₀+C₁)/E)^{1/2}.

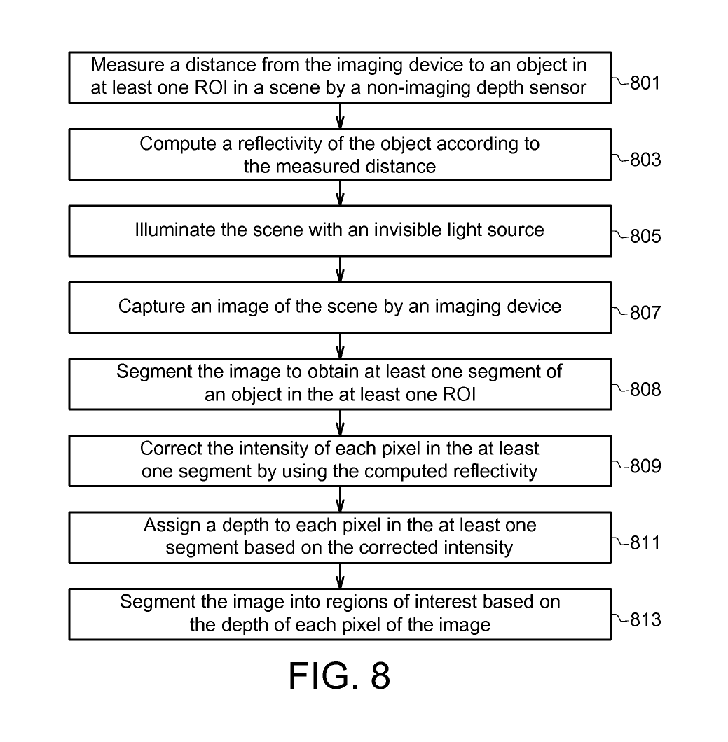

Referring to FIG. 8, a flow chart of a depth-based segmentation image processing according to the second embodiment is illustrated. The depth-based segmentation image processing is an application of the method for obtaining depth information in the scene according to the second embodiment. Therefore, the depth-based segmentation image processing includes the steps 801 to 811 identical to the steps 601 to 611 in FIG. 6 and further includes the step 813. In other words, the depth information obtained by performing the steps 801 to 811 is applied in the depth-based segmentation image processing. In step 813, the image is segmented into regions of interest based on the depth of each pixel in the at least one segment.

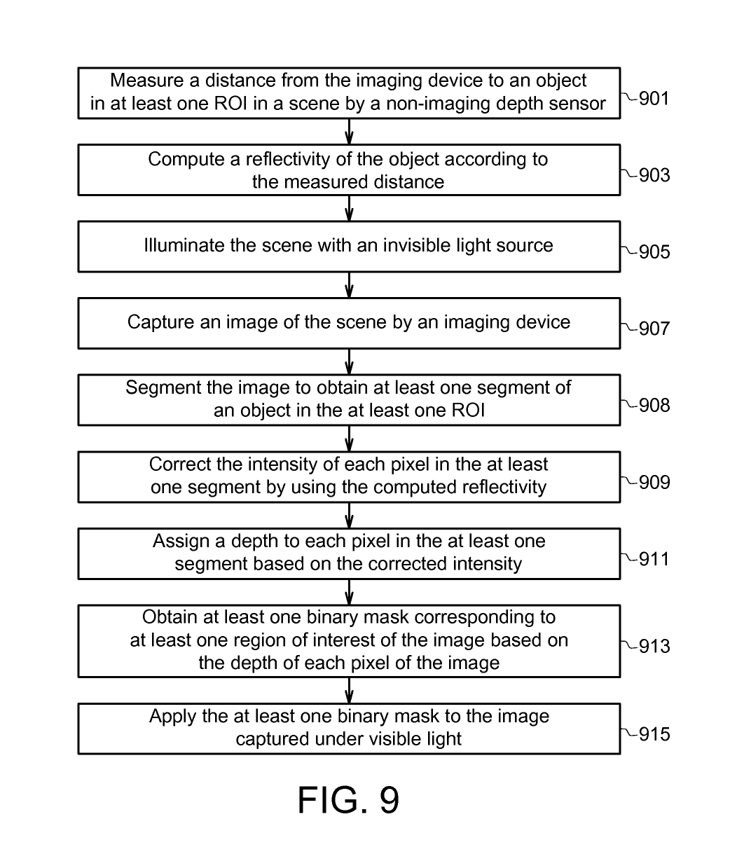

Referring to FIG. 9, a flow chart of a matting image processing according to the second embodiment is illustrated. The imaging device is capable of capturing images in both the invisible optical spectrum and in visible light. The matting image processing is another application of the method for obtaining depth information in the scene according to the second embodiment. Therefore, the matting image processing includes the steps 901 to 911 identical to the steps 601 to 611 in FIG. 6 and further includes the steps 913 and 915. In other words, the depth information obtained by performing the steps 901 to 911 is applied in the matting image processing. In step 913, at least one binary mask corresponding to at least one region of interest of the image may be obtained based on the depth of each pixel of the image. In step 915, the at least one binary mask is applied to the image captured under visible light.

The apparatus and method according to the disclosed embodiments can reduce the computation load while allowing depth evaluation to be performed under various conditions, in and outdoor, and can assist in obtaining a reliable depth estimation from the measured light reflected by an object.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. An apparatus for obtaining depth information in a scene, the apparatus comprising:
an imaging device, for capturing an image of the scene, the imaging device comprising:
a lens;
an imaging sensor; and
a processing unit capable of performing computation operations on the image; and
at least one non-imaging depth sensor, for measuring a distance from the imaging device to an object in at least one region of interest of the image captured by the imaging sensor;
wherein the processing unit assigns a depth to the object in the at least one region of interest according to the measured distance.

2. The apparatus according to claim 1, wherein the imaging sensor is sensitive to invisible light.

3. The apparatus according to claim 2, further comprising an invisible light light source.

4. The apparatus according to claim 3, wherein the invisible light light source is a source of infrared light.

5. The apparatus according to claim 1, wherein the at least one non-imaging depth sensor is an ultrasound transducer.

6. The apparatus according to claim 1, wherein the at least one non-imaging depth sensor is a phase detection sensor.

7. The apparatus according to claim 1, wherein a directivity of the non-imaging depth sensor is capable of being steered along a direction.

8. The apparatus according to claim 1, wherein the imaging sensor is sensitive to both visible and invisible light.

9. The apparatus according to claim 8, further comprising an invisible light light source.

10. The apparatus according to claim 9, wherein the invisible light light source is a source of infrared light.

11. The apparatus according to claim 8, wherein the at least one non-imaging depth sensor is an ultrasound transducer.

12. The apparatus according to claim 8, wherein the at least one non-imaging depth sensor is a phase detection sensor.

13. A method for obtaining depth information in a scene, the method comprising:
capturing an image of the scene by an imaging device;
segmenting the image to obtain at least one segment of an object in at least one region of interest;
measuring a distance from the imaging device to the object in the at least one region of interest by a non-imaging depth sensor; and
assigning a depth to the at least one segment of the object according to the measured distance.

14. The method according to claim 13, further comprising:
steering a directivity of the non-imaging depth sensor toward a direction of the object in the at least one region of interest.

15. A method for obtaining depth information in a scene, the method comprising:
measuring a distance from the imaging device to an object in at least one region of interest in the scene by a non-imaging depth sensor;
computing a reflectivity of the object according to the measured distance;
illuminating the scene with an invisible light light source;
capturing an image of the scene by an imaging device;
segmenting the image to obtain at least one segment of the object in the at least one region of interest;
correcting an intensity of each pixel in the at least one segment by using the computed reflectivity; and
assigning a depth to each pixel in the at least one segment based on the corrected intensity.

16. The method according to claim 15, wherein the image of the scene is captured only in an invisible domain of an optical spectrum.

17. The method according to claim 15, wherein the image of the scene is captured both in invisible and visible domains of an optical spectrum.

18. The method according to claim 15, wherein the step of computing the reflectivity of the object comprising:
using a Phong model to obtain the reflectivity of the object.

19. The method according to claim 15, further comprising:
performing a depth-based segmentation by segmenting the image into regions of interest based on the depth of each pixel in the at least one segment.

20. The method according to claim 15, further comprising:
performing a matting operation by:
obtaining at least one binary mask corresponding to at least one region of interest of the image based on the depth of each pixel in the at least one segment; and
applying the at least one binary mask to the image captured under visible light.
